(19) United States
(12) Patent Application Publication
(10) Pub. No.: US 2022/0383532 A1
(43) Pub. Date: Dec. 1, 2022

(54) SURFACE GRID SCANNING AND DISPLAY METHOD, SYSTEM AND APPARATUS

(71) Applicant: QINGDAO PICO TECHNOLOGY CO., LTD., Laoshan District (CN)

(72) Inventor: Tao WU, Qingdao (CN)

(21) Appl. No.: 17/886,006

(22) Filed: Aug. 11, 2022

Related U.S. Application Data
(63) Continuation of application No. PCT/CN2021/121004, filed on Sep. 27, 2021.

(30) Foreign Application Priority Data
May 10, 2021 (CN) 202110504681.5

(51) Int. Cl. G06T 7/593; G06T 7/70; G06T 7/521

(52) U.S. Cl. CPC G06T 7/593; G06T 7/70; G06T 7/521

(57) ABSTRACT

Provided are a surface grid scanning and display method, system and apparatus. The method comprises: calibrating all scanning devices located in a same three-dimensional space environment; scanning the three-dimensional space environment by the scanning devices, and generating three-dimensional scanning data corresponding to the scanning devices; obtaining pose information of each frame of the three-dimensional scanning data relative to the three-dimensional space environment; obtaining, based on the pose information and the three-dimensional scanning data, a first sparse 3D surface grid, corresponding to each scanning device, of the three-dimensional space environment; obtaining a second sparse 3D surface grid, corresponding to each scanning device, of a three-dimensional space environment outside a current scanning environment area; and rendering and displaying a combination of the first sparse 3D surface grid and the second sparse 3D surface grid by the scanning device corresponding to the first sparse 3D surface grid.

### CROSS-REFERENCE TO RELATED APPLICATION

The present disclosure is a continuation application of PCT Application No. PCT/2021/121004 filed on Sep. 27, 2021, which claims priority to Chinese Patent Application No. 202110504681.5, filed with China National Intellectual Property Administration on May 10, 2021, entitled “Surface Grid Scanning and Display Method, System and Apparatus”, the entire contents of which is incorporated by reference herein.

### TECHNICAL FIELD

The present disclosure relates to the field of artificial reality technology, and more specifically, to a surface grid scanning and display method, system and apparatus.

### BACKGROUND

With the advancement of society and the development of technology, artificial reality systems are becoming more and more common in the fields of computer games, health and safety, industry and education. For example, artificial reality systems are being integrated into mobile devices, game consoles, personal computers, movie theaters, and theme parks. Generally, artificial reality is a form of reality adjusted in a certain way before being presented a user. Artificial reality can comprise, for example, virtual reality (VR), augmented reality (AR), mixed reality (MR), mixed reality, or some combinations and/or derivatives thereof. A typical artificial reality system uses one or more devices to interact with the system and presents and displays content to one or more users. As an example, the artificial reality system may comprise a head-mounted display (HMD) worn by a user and configured to output artificial reality content to the user.

Currently, in some applications of the artificial reality systems, the artificial reality systems create virtual images (such as holograms) based on physical features in the real world. For example, an artificial reality system can project a dinosaur which is passing through a bedroom wall, or can guide the user to navigate between rooms. For example, a displayed room may emit smoke due to a fire disaster, so visibility is very limited. In this case, the artificial reality system can help the user navigate by presenting a navigation virtual image of an escape route. In order to make virtual images and experiences as real and useful as possible, the artificial reality system uses depth and surface features of the room to determine how to best create any virtual image. A surface grid beneficially provides this valuable information for the artificial reality system.

It can be seen that the surface grid of construction environment plays a very important and key role in the current artificial reality system.

However, in existing scenarios that require multiple users to perform some cooperative activities, for example, in education and training scenarios such as fire drills, due to complexity of three-dimensional (3D) space gridding, the efficiency of multi-person cooperation is relatively low, which greatly reduces authenticity of experience of a scene.

### SUMMARY

In view of the above problem, embodiments of the present disclosure provide a surface grid scanning and display method, system and apparatus, which can solve the problem that user experience is affected because of redundancy of scanning areas of a surface grid in related art, as well as low efficiency of cooperation among devices.

Provided by some embodiments of the present disclosure is a surface grid scanning and display method. The method comprises: calibrating all scanning devices located in a same three-dimensional space environment, so that all the scanning devices are located in a same coordinate system; scanning the three-dimensional space environment by the scanning devices, and generating three-dimensional scanning data corresponding to the scanning devices; obtaining pose information of each frame of the three-dimensional scanning data relative to the three-dimensional space environment; obtaining, based on the pose information and the three-dimensional scanning data, a first sparse 3D surface grid, corresponding to each scanning device, of the three-dimensional space environment; obtaining, based on the first sparse 3D surface grid, a second sparse 3D surface grid, corresponding to each scanning device, of a three-dimensional space environment outside a current scanning environment area; and rendering and displaying a combination of the first sparse 3D surface grid and the second sparse 3D surface grid by the scanning device corresponding to the first sparse 3D surface grid.

In at least one exemplary embodiment, calibrating all scanning devices located in a same three-dimensional space environment comprises: selecting any one of the scanning devices as a target scanning device; performing a full scan of the three-dimensional space environment through the target scanning device to generate digital map information in the current three-dimensional space environment, wherein a scanning area of the target device comprises any one of physical space areas in the current three-dimensional space environment; sending the digital map information to a non-target scanning device other than the target scanning device through a server; and constructing local map information corresponding to the three-dimensional space environment and matching the digital map information to the local map information by the non-target scanning device, so as to complete the calibration of all the scanning devices.

In at least one exemplary embodiment, matching the digital map information to the local map information comprises matching of feature points and matching of descriptors.

In at least one exemplary embodiment, obtaining pose information of each frame of the three-dimensional scanning data relative to the three-dimensional space environment comprises: obtaining the positioning and tracking information in each frame through a positioning and tracking module in a head-mounted apparatus provided with the scanning devices; and obtaining the pose information corresponding to each frame based on the positioning and tracking information.

In at least one exemplary embodiment, obtaining a first sparse 3D surface grid, corresponding to each scanning device, of the three-dimensional space environment comprises: obtaining a first 3D surface grid, corresponding to each scanning device, in the current three-dimensional space environment, so that every three points in corresponding digital map information are connected into a triangle according to a preset rule; randomly determining a center point in the first 3D surface grid, and determining Euclidean distances between the center point and grid points other than the center point; and traversing all the grid points, and deleting grid points of which the Euclidean distances meet a preset threshold range, and forming the first sparse 3D surface grid by remaining grid points.

In at least one exemplary embodiment, the preset threshold value ranges from 2 cm to 5 cm.

In at least one exemplary embodiment, obtaining a second sparse 3D surface grid, corresponding to each scanning device, of a three-dimensional space environment outside a current scanning environment area comprises: obtaining a current scanning area of each scanning device in the three-dimensional space environment based on the first sparse 3D surface grid, corresponding to each scanning device, of the three-dimensional space environment; and performing data exchange among all the scanning devices, and determining, based on the current scanning areas of all the scanning devices, the second sparse 3D surface grid, corresponding to each scanning device, of the three-dimensional space environment outside the current scanning area.

In at least one exemplary embodiment, each scanning device comprises at least two tracking cameras; an angle of view of each of the at least two tracking cameras is not less than 135°*98°; and a tracking angle of view of each scanning device is not less than 200°*185°.

In at least one exemplary embodiment, after obtaining the pose information of each frame of the three-dimensional scanning data relative to the three-dimensional space environment, the method further comprises an operation of sending the pose information and the three-dimensional scanning data to a server to instruct the server to perform the following operations: according to the pose information and the three-dimensional scanning data, generating a first 3D surface grid of the current three-dimensional space environment through a curved surface reconstruction technology; and down-sampling the first 3D surface grid, and performing sparse processing on data of the first 3D surface grid, so as to form the first sparse 3D surface grid of the current three-dimensional space environment.

In at least one exemplary embodiment, the current scanning area of each scanning device comprises a scanning range of a positioning and tracking module on the scanning device.

According to another aspect of the embodiments of the present disclosure, provided is a surface grid scanning and display system. The system comprises: a calibration unit configured to calibrate all scanning devices located in a same three-dimensional space environment, so that all the scanning devices are located in a same coordinate system; a three-dimensional scanning data generating unit configured to scan the three-dimensional space environment by the scanning devices, and generate three-dimensional scanning data corresponding to the scanning devices; a pose information obtaining unit configured to obtain pose information of each frame of the three-dimensional scanning data relative to the three-dimensional space environment; a first 3D surface grid obtaining unit configured to obtain, based on the pose information and the three-dimensional scanning data, a first sparse 3D surface grid, corresponding to each scanning device, of the three-dimensional space environment; a second 3D surface grid obtaining unit configured to obtain, based on the first sparse 3D surface grid, a second sparse 3D surface grid, corresponding to each scanning device, of a three-dimensional space environment outside a current scanning environment area; and a surface grid display unit configured to render and display a combination of the first sparse 3D surface grid and the second sparse 3D surface grid by the scanning device corresponding to the first sparse 3D surface grid.

According to another aspect of the embodiments of the present disclosure, further provided is a head-mounted apparatus. The electronic apparatus comprises a display, at least one processing unit, at least two depth cameras or scanning sensors, and one or more computer-readable hardware storage apparatus, wherein the at least one processing unit is configured to execute the above-mentioned surface grid scanning and display methods.

In at least one exemplary embodiment, each of the at least two depth cameras comprises at least one of the following cameras: a Time-of-flight (TOF) camera, a structured light camera, an active stereo camera pair, a passive stereo camera.

According to another aspect of the embodiments of the present disclosure, further provided is an electronic apparatus, wherein the electronic apparatus comprises the surface grid scanning and display system as described in the aforementioned embodiments; or, comprises a memory and a processor, wherein the memory is configured to store computer instructions, and the processor is configured to call the computer instructions from the memory to execute any one of the above-mentioned surface grid scanning and display methods.

According to another aspect of the embodiments of the present disclosure, provided is a computer-readable storage medium with a computer program stored thereon, wherein the computer program, when executed by a processor, implements the surface grid scanning and display method described in any one of the above-mentioned embodiments.

With the above-mentioned surface grid scanning and display method, system and apparatus, by the following operations, a fast speed, high efficiency, and good user experience are obtained as a result of the improved cooperation efficiency among multiple devices, quick construction of the surface grid data in 3D space, and prevention of generation of redundant scanning data from a same area: calibrating all scanning devices located in the same three-dimensional space environment, so that all the scanning devices are located in the same coordinate system; scanning the three-dimensional space environment by the scanning devices, and generating three-dimensional scanning data corresponding to the scanning devices; obtaining the pose information of each frame of the three-dimensional scanning data relative to the three-dimensional space environment; obtaining, based on the pose information and the three-dimensional scanning data, the first sparse 3D surface grid, corresponding to each scanning device, of the three-dimensional space environment; obtaining the second sparse 3D surface grid of the three-dimensional space environment outside the current scanning environment area for each scanning device; and rendering and displaying the combination of the first sparse 3D surface grid and the second sparse 3D surface grid by the scanning device corresponding to the first sparse 3D surface grid.

One or more aspects of the embodiments of the present disclosure comprise features that will be described in detail later. The following description and drawings illustrate certain exemplary aspects of the embodiments of the present disclosure in detail. However, these aspects indicate only some of the various ways in which the principles of the present disclosure can be used. Furthermore, the present disclosure is intended to comprise all these aspects and their equivalents.

### BRIEF DESCRIPTION OF THE DRAWINGS

By referring to the following description in conjunction with the accompanying drawings, and with a more comprehensive understanding of the embodiments of the present disclosure, other purposes and results of the embodiments of the present disclosure will be more clear and easy to understand. In the figures:

FIG. 1 is a flowchart of a surface grid scanning and display method according to some embodiments of the present disclosure;

FIG. 2 is a schematic block diagram of a surface grid scanning and display system according to some embodiments of the present disclosure.

A same reference numeral in all the drawings indicates a similar or corresponding feature or function.

### DETAILED DESCRIPTION OF THE EMBODIMENTS

In the following description, for illustrative purposes, in order to provide a comprehensive understanding of one or more embodiments, many exemplary details are set forth. However, it is obvious that these embodiments can also be implemented without these exemplary details. In other examples, for the convenience of describing one or more embodiments, well-known structures and devices are shown in a form of block diagrams.

In the description of the present disclosure, it should be understood that the orientation or positional relationship indicated by the terms “center”, “longitudinal”, “transverse”, “length”, “width”, “thickness”, “upper”, “lower”, “front”, “back”, “left”, “right”, “vertical”, “horizontal”, “top”, “bottom”, “inner”, “outer”, “clockwise”, “counterclockwise”, “axial”, “radial”, “circumferential”, etc. is based on the orientation or positional relationship shown in the drawings, and is only for the convenience of describing the present disclosure and simplifying the description, rather than indicating or implying the apparatus or element being referred to must have a particular orientation, be constructed and operated in a particular orientation, and therefore cannot be construed as a limitation to the present disclosure.

In order to describe the surface grid scanning and display method, system and apparatus provided by the present disclosure in details, specific embodiments of the present disclosure will be described in detail below with reference to the accompanying drawings.

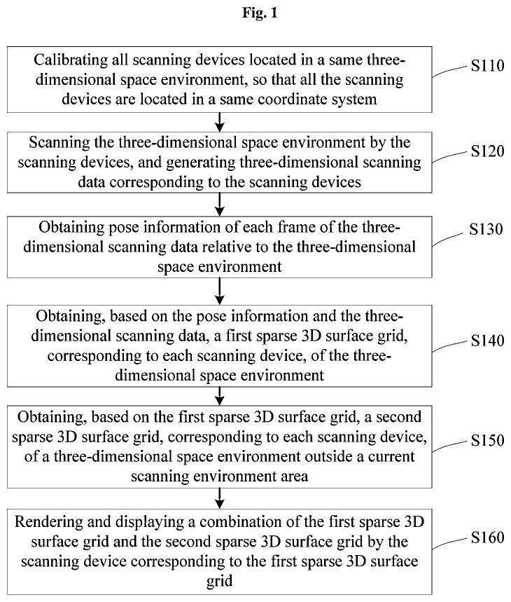

FIG. 1 is a flowchart of a surface grid scanning and display method according to some embodiments of the present disclosure.

As shown in FIG. 1, a surface grid scanning and display method in some embodiments of the present disclosure comprises the following operations S110 to S160.

At S110, all scanning devices located in a same three-dimensional space environment are calibrated, so that all the scanning devices are located in a same coordinate system.

The operation that all scanning devices located in a same three-dimensional space environment are calibrated comprises the following operations. Any one of the scanning devices is selected as a target scanning device. A full scan of the three-dimensional space environment is performed through the target scanning device to generate digital map information in the current three-dimensional space environment, wherein a scanning area of the target device comprises as much as possible any one of physical space areas in the current three-dimensional space environment. The digital map information is sent to a non-target scanning device other than the target scanning device through a server; and after receiving the signal sent by the server, local map information corresponding to the three-dimensional space environment is constructed and the digital map information is matched to the local map information by the non-target scanning device, so as to complete the calibration of all the scanning devices.

Furthermore, matching methods in related art, such as matching of feature points and matching of descriptors, may be employed for matching the digital map information to the local map information. The present disclosure does not specifically limit the matching method.

At S120, the three-dimensional space environment is scanned by the scanning devices, and three-dimensional scanning data corresponding to the scanning devices is generated.

At S130, pose information of each frame of the three-dimensional scanning data relative to the three-dimensional space environment is obtained.

In the above operations S120 and S130, multiple scanning devices or user devices scan the current three-dimensional space environment at the same time and generate the three-dimensional scanning data corresponding to the respective scanning devices, and obtain the pose information of each frame of the three-dimensional scanning data relative to the current three-dimensional space environment through positioning and tracking modules of the scanning devices in the meanwhile.

As an exemplary implementation, the operation that pose information of each frame of the three-dimensional scanning data relative to the three-dimensional space environment is obtained comprises the following operations. The positioning and tracking information in each frame is obtained through the positioning and tracking module in a head-mounted apparatus provided with the scanning devices. The pose information corresponding to each frame is obtained based on the positioning and tracking information.

At S140, a first sparse 3D surface grid, corresponding to each scanning device, of the three-dimensional space environment is obtained based on the pose information and the three-dimensional scanning data.

After obtaining the three-dimensional scanning data and pose information of each scanning device, the three-dimensional scanning data and the pose information are sent to the server, which may be a central processing unit or other types of servers. The server generates, according to the three-dimensional scanning data and the pose information sent by the scanning devices, a first 3D surface grid of the current three-dimensional space environment through a curved surface reconstruction technology, down-samples the first 3D surface grid, and performs sparse processing on data of the first 3D surface grid, so as to form the first sparse 3D surface grid of the current three-dimensional space environment.

As an exemplary implementation, the operation that a first sparse 3D surface grid, corresponding to each scanning device, of the three-dimensional space environment is obtained comprises the following operations. A first 3D surface grid, corresponding to each scanning device, in the current three-dimensional space environment is obtained, so that every three points in corresponding digital map information are connected into a triangle according to a preset rule. A center point in the first 3D surface grid is randomly determined, and Euclidean distances between the center point and grid points other than the center point are determined. All the grid points are traversed, grid points of which the Euclidean distances meet a preset threshold range are deleted, and the first sparse 3D surface grid is formed by remaining grid points.

The preset threshold value ranges from 2 cm to 5 cm.

At S150, a second sparse 3D surface grid, corresponding to each scanning device, of a three-dimensional space environment outside a current scanning environment area is obtained based on the first sparse 3D surface grid.

The operation that a second sparse 3D surface grid, corresponding to each scanning device, of a three-dimensional space environment outside a current scanning environment area is obtained comprises the following operations. A current scanning area of each scanning device in the three-dimensional space environment is obtained based on the first sparse 3D surface grid, corresponding to each scanning device, of the three-dimensional space environment. Data exchange is performed among all the scanning devices, and the second sparse 3D surface grid, corresponding to each scanning device, of the three-dimensional space environment outside the current scanning area is determined based on the current scanning areas of all the scanning devices.

As an exemplary implementation, the positioning and tracking information of each scanning device (or each user device) relative to the three-dimensional space environment at the moment, i.e., 6DoF data in the current three-dimensional space environment, can be obtained through the server. In an exemplary implementation of the embodiments of the present disclosure, the scanning range or scanning area of each scanning device is the scanning range of the positioning and tracking device (positioning and tracking module) of the user scanning device. For example, the positioning and tracking device can be 2 or more tracking cameras provided in the user device and built-in according to a certain position relationship. Each tracking camera has a Field of View (FOV) range, for example, a tracking angle of view of FOV of each tracking camera is 135°*98°, i.e., tracking angles of view of 2 or more tracking cameras will splice together to form the tracking FOV of one scanning device. In the embodiments of the present disclosure, the tracking FOV of each scanning device is not less than: 200°*185° (H*V).

It should be noted that the scanning range of each frame of each scanning device can be determined according to the tracking range of each scanning device. The angle of view of each tracking camera may be not less than 135°*98°. The tracking angle of view of each scanning device may be not less than 200°*185°. The range of each angle of view is not specifically limited in this application, and can be adjusted according to a configuration of the scanning device or the requirements of a scene.

According to the above information, the scanning area of each scanning user in the current three-dimensional space environment can be calculated, and the 3D grid data outside the scanning area can be obtained and sparsely processed to determine the second sparse 3D surface grid.

At S160, a combination of the first sparse 3D surface grid and the second sparse 3D surface grid is rendered and displayed by the scanning device corresponding to the first sparse 3D surface grid.

When the scanning device finds that some areas of the three-dimensional space environment have been scanned by other scanning devices, this scanning device does not need to scan these areas repeatedly, but enters other environmental areas that have not been scanned by other scanning devices for scanning. On this basis, each scanning device exchanges data with each other for several times, so scanning efficiency among the scanning devices is improved and redundant data is prevented from being provided to the system.

Finally, the first sparse 3D surface grid and the second sparse 3D surface grid can be combined, and then rendered and displayed by the scanning devices to form complete surface grid data in the current three-dimensional space environment.

Corresponding to the above-mentioned surface grid scanning and display method, also provided by some embodiments of the present disclosure is a surface grid scanning and display system.

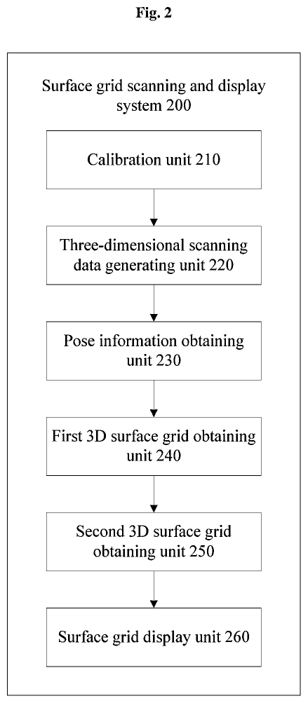

FIG. 2 shows a schematic logic of the surface grid scanning and display system according to some embodiments of the present disclosure.

As shown in FIG. 2, a surface grid scanning and display system 200 in some embodiments of the present disclosure comprises:

a calibration unit 210 configured to calibrate all scanning devices located in a same three-dimensional space environment, so that all the scanning devices are located in a same coordinate system;

a three-dimensional scanning data generating unit 220 configured to scan the three-dimensional space environment by the scanning devices, and generate three-dimensional scanning data corresponding to the scanning devices;

a pose information obtaining unit 230 configured to obtain pose information of each frame of the three-dimensional scanning data relative to the three-dimensional space environment;

a first 3D surface grid obtaining unit 240 configured to obtain, based on the pose information and the three-dimensional scanning data, a first sparse 3D surface grid, corresponding to each scanning device, of the three-dimensional space environment;

a second 3D surface grid obtaining unit 250 configured to obtain, based on the first sparse 3D surface grid, a second sparse 3D surface grid, corresponding to each scanning device, of a three-dimensional space environment outside a current scanning environment area; and

a surface grid display unit 260 configured to render and display a combination of the first sparse 3D surface grid and the second sparse 3D surface grid by the scanning device corresponding to the first sparse 3D surface grid.

In some other embodiments of the present disclosure, also provided is a head-mounted apparatus, wherein the head-mounted apparatus comprises a display, at least one processing unit, at least two depth cameras or scanning sensors, and one or more computer-readable hardware storage apparatus, wherein the at least one processing unit is configured to execute the above-mentioned surface grid scanning and display methods.

The above-mentioned depth camera (or 3D scanning sensor, which is called “scanning sensor” for short) comprises any type of depth camera or depth detector. For example, a time-of-flight (“TOF”) camera, a structured light camera, an active stereo camera pair, a passive stereo camera pair, or any other type of camera, sensor, laser, or device capable of detecting or determining depth.

It should be noted that, the details of the above-mentioned embodiments of the surface grid scanning and display system and the head-mounted apparatus will not be repeated herein, please refer to the description in the embodiments of the surface grid scanning and display method for the details.

Also provided by some embodiments of the present disclosure is an electronic apparatus, wherein the electronic apparatus comprises the surface grid scanning and display system 200 as described in FIG. 2; or, a memory and a processor, wherein the memory is configured to store computer instructions, and the processor is configured to call the computer instructions from the memory to execute any one of the above-mentioned surface grid scanning and display method.

Also provided by some embodiments of the present disclosure is a computer-readable storage medium with a computer program stored thereon, wherein the computer program, when executed by a processor, implements the surface grid scanning and display method in any one of above-mentioned embodiments.

According to the above-mentioned surface mesh scanning and display method, system and apparatus in the present disclosure, the 3D surface mesh reconstruction data is constructed, and the data is exchanged among multiple scanning devices, which helps prevent redundant generation of the 3D scanning data for the same area and greatly improves the low cooperation efficiency of the multiple devices. Therefore, the surface grid scanning has a fast speed and high efficiency, providing a good user experience.

The surface grid scanning and display method, system, and apparatus according to the present disclosure are described as above by a way of examples with reference to the drawings. However, a person having ordinary skill in the art should understand that various improvements can be made to the surface grid scanning and display method, system, and apparatus proposed in the present disclosure without departing from the contents of this application. Therefore, the protection scope of the present disclosure should be determined by the contents of the appended claims.

What is claimed is:

1. A surface grid scanning and display method, wherein the method comprises:
calibrating, through a server, all scanning devices located in a same three-dimensional space environment, so that all the scanning devices are located in a same coordinate system;
scanning, by the scanning devices, the three-dimensional space environment, and generating, by the scanning devices, three-dimensional scanning data corresponding to the scanning devices and sending, by the scanning devices, the three-dimensional scanning data to the server;
obtaining, by the scanning devices, pose information of each frame of the three-dimensional scanning data relative to the three-dimensional space environment and sending, by the scanning devices, the pose information to the server;
obtaining, by the server based on the pose information and the three-dimensional scanning data, a first sparse three-dimensional (3D) surface grid, corresponding to each scanning device, of the three-dimensional space environment;
obtaining, by the scanning devices based on the first sparse 3D surface grid, a second sparse 3D surface grid, corresponding to each scanning device, of a three-dimensional space environment outside a current scanning environment area; and
rendering and displaying, by the scanning devices, a combination of the first sparse 3D surface grid and the second sparse 3D surface grid by the scanning device corresponding to the first sparse 3D surface grid.

2. The surface grid scanning and display method according to claim 1, wherein calibrating, through a server, all scanning devices located in a same three-dimensional space environment comprises:
selecting any one of the scanning devices as a target scanning device;
performing a full scan of the three-dimensional space environment through the target scanning device to generate digital map information in the current three-dimensional space environment, wherein a scanning area of the target device comprises any one of physical space areas in the current three-dimensional space environment;
sending, through the server, the digital map information to a non-target scanning device other than the target scanning device; and
constructing local map information corresponding to the three-dimensional space environment and matching the digital map information to the local map information by the non-target scanning device, so as to complete the calibration of all the scanning devices.

3. The surface grid scanning and display method according to claim 2, wherein
matching the digital map information to the local map information comprises matching of feature points and matching of descriptors.

4. The surface grid scanning and display method according to claim 1, wherein obtaining, by the scanning devices, pose information of each frame of the three-dimensional scanning data relative to the three-dimensional space environment comprises:
obtaining positioning and tracking information in each frame through a positioning and tracking module in a head-mounted apparatus provided with the scanning devices; and
obtaining the pose information corresponding to each frame based on the positioning and tracking information.

5. The surface grid scanning and display method according to claim 1, wherein obtaining, by the server, a first sparse 3D surface grid, corresponding to each scanning device, of the three-dimensional space environment comprises:
obtaining a first 3D surface grid, corresponding to each scanning device, in the current three-dimensional space environment, so that every three points in corresponding digital map information are connected into a triangle according to a preset rule;
randomly determining a center point in the first 3D surface grid, and determining Euclidean distances between the center point and grid points other than the center point; and
traversing all the grid points, and deleting grid points of which the Euclidean distances meet a preset threshold range, and forming the first sparse 3D surface grid by remaining grid points.

6. The surface grid scanning and display method according to claim 5, wherein
the preset threshold value ranges from 2 cm to 5 cm.

7. The surface grid scanning and display method according to claim 1, wherein obtaining, by the scanning devices, a second sparse 3D surface grid, corresponding to each scanning device, of a three-dimensional space environment outside a current scanning environment area comprises:
obtaining a current scanning area of each scanning device in the three-dimensional space environment based on the first sparse 3D surface grid, corresponding to each scanning device, of the three-dimensional space environment; and
performing data exchange among all the scanning devices, and determining, based on the current scanning areas of all the scanning devices, the second sparse 3D surface grid, corresponding to each scanning device, of the three-dimensional space environment outside the current scanning area.

8. The surface grid scanning and display method according to claim 1, wherein
each scanning device comprises at least two tracking cameras;
an angle of view of each of the at least two tracking cameras is not less than 135°*98°; and
a tracking angle of view of each scanning device is not less than 200°*185°.

9. The surface grid scanning and display method according to claim 1, wherein after obtaining, by the scanning devices, the pose information of each frame of the three-dimensional scanning data relative to the three-dimensional space environment, the method further comprises:
sending the pose information and the three-dimensional scanning data to the server to instruct the server to perform the following operations:
according to the pose information and the three-dimensional scanning data, generating a first 3D surface grid of the current three-dimensional space environment through a curved surface reconstruction technology; and
down-sampling the first 3D surface grid, and performing sparse processing on data of the first 3D surface grid, so as to form the first sparse 3D surface grid of the current three-dimensional space environment.

10. The surface grid scanning and display method according to claim 1, wherein the current scanning area of each scanning device comprises a scanning range of a positioning and tracking module on the scanning device.

11. A surface grid scanning and display system, wherein the system comprises a server and scanning devices, wherein:
all scanning devices located in a same three-dimensional space environment are calibrated, so that all the scanning devices are located in a same coordinate system;
the scanning devices are configured to scan the three-dimensional space environment, and generate three-dimensional scanning data corresponding to the scanning devices and send the three-dimensional scanning data to the server;
the scanning devices are configured to obtain pose information of each frame of the three-dimensional scanning data relative to the three-dimensional space environment and send the pose information to the server;
the server is configured to obtain, based on the pose information and the three-dimensional scanning data, a first sparse three-dimensional (3D) surface grid, corresponding to each scanning device, of the three-dimensional space environment;
the scanning devices are configured to obtain, based on the first sparse 3D surface grid, a second sparse 3D surface grid, corresponding to each scanning device, of a three-dimensional space environment outside a current scanning environment area; and
the scanning devices are configured to render and display a combination of the first sparse 3D surface grid and the second sparse 3D surface grid by the scanning device corresponding to the first sparse 3D surface grid.

12. A head-mounted apparatus, wherein the head-mounted apparatus comprises a display, at least one processing unit, at least two depth cameras or scanning sensors, and one or more computer-readable hardware storage apparatus, wherein the at least one processing unit is configured to execute the surface grid scanning and display method according to claim 1.

13. The head-mounted apparatus according to claim 12, wherein each of the at least two depth cameras comprises at least one of the following cameras:
a Time-of-flight (TOF) camera, a structured light camera, an active stereo camera pair, a passive stereo camera.

14. A non-transitory computer-readable storage medium with a computer program stored thereon, wherein the computer program, when executed by a processor, implements the method according to claim 1.

15. The surface grid scanning and display system according to claim 11, wherein the server is configured to select any one of the scanning devices as a target scanning device;
the target scanning device is configured to perform a full scan of the three-dimensional space environment to generate digital map information in the current three-dimensional space environment, wherein a scanning area of the target device comprises any one of physical space areas in the current three-dimensional space environment;
the server is configured to send the digital map information to a non-target scanning device other than the target scanning device; and
the non-target scanning device is configured to construct local map information corresponding to the three-dimensional space environment and match the digital map information to the local map information, so as to complete the calibration of all the scanning devices.

16. The surface grid scanning and display system according to claim 11, wherein
matching the digital map information to the local map information comprises matching of feature points and matching of descriptors.

17. The surface grid scanning and display system according to claim 11, wherein the scanning devices are configured to:
obtain positioning and tracking information in each frame through a positioning and tracking module in a head-mounted apparatus provided with the scanning devices; and
obtain the pose information corresponding to each frame based on the positioning and tracking information.

18. The surface grid scanning and display system according to claim 11, wherein the server is configured to:
obtain a first 3D surface grid, corresponding to each scanning device, in the current three-dimensional space environment, so that every three points in corresponding digital map information are connected into a triangle according to a preset rule;
randomly determine a center point in the first 3D surface grid, and determine Euclidean distances between the center point and grid points other than the center point; and
traverse all the grid points, and deleting grid points of which the Euclidean distances meet a preset threshold range, and form the first sparse 3D surface grid by remaining grid points.

19. The surface grid scanning and display system according to claim 11, wherein the scanning devices, after obtaining the pose information of each frame of the three-dimensional scanning data relative to the three-dimensional space environment, are further configured to:
send the pose information and the three-dimensional scanning data to the server to instruct the server to perform the following operations:
according to the pose information and the three-dimensional scanning data, generate a first 3D surface grid of the current three-dimensional space environment through a curved surface reconstruction technology; and
down-sample the first 3D surface grid, and perform sparse processing on data of the first 3D surface grid, so as to form the first sparse 3D surface grid of the current three-dimensional space environment.

20. The surface grid scanning and display system according to claim 11, wherein the current scanning area of each scanning device comprises a scanning range of a positioning and tracking module on the scanning device.
